(19) United States
(12) Patent Application Publication
(10) Pub. No.: US 2013/0268310 A1
(43) Pub. Date: Oct. 10, 2013

(54) SCHEDULING SYSTEM, METHOD AND COMPUTER-READABLE MEDIUM

(71) Applicant: Ryan W. Wilson, Gloucester, VA (US)

(72) Inventor: Ryan W. Wilson, Gloucester, VA (US)

(21) Appl. No.: 13/834,344

(22) Filed: Mar. 15, 2013

Related U.S. Application Data
(60) Provisional application No. 61/620,590, filed on Apr. 5, 2012.

(51) Int. Cl. G06Q 10/06

(52) U.S. Cl. CPC G06Q 10/063116
USPC 705/7.16

(57) ABSTRACT

There is a system for performing scheduling. The system includes a processor to perform dynamic priority scheduling based on a schedule including one or more flexible events associated with a flexible event object. The flexible event object includes a FlexibleDueTime and at least one of a FlexibleStartTime and a FlexibleEventDuration. The processor generates a priority value associated with the flexible event based on a time, the FlexibleDueTime, and at least one of the FlexibleStartTime and the FlexibleEventDuration. The system determines a priority assignment for the flexible event utilizing the generated priority value. There are also associated methods and computer-readable mediums for performing scheduling.

### BACKGROUND OF THE INVENTION

Tasks are commonly stand-alone pieces of work. But often tasks are part of a set of actions to complete a large or complex job, problem, or assignment. Tasks may be accomplished by persons, acting as individuals or as part of a group. In a similar way, a group may also accomplish tasks, as an independent group or as part of a larger group. In many instances, task planning and time management for individuals or groups are often constrained by parameters, such as an individual person's abilities, scheduled events, previously scheduled tasks as well as parameters relating to a planned task, such as its scope, quality, quantity, budget, as well as other potential parameters.

Time management is commonly practiced by persons through the scheduling of tasks and events for purposes such as improving effectiveness and efficiency, and for coordinating plans with others. Effective time management is important for individuals as well as for organizations, such as businesses, schools, government units and other entities. For example, within a business context, task planning commonly involves the organization and management of resources to complete specific goals and objectives. In addition, individuals and groups of individuals may be restricted from completing certain tasks within certain time frames due to limitations upon their available time.

Time limitations are often due to special events in a schedule. More commonly, in any schedule there are often periods which are blocked-out for various and often ordinary reasons, such as those time periods commonly reserved for sleeping, eating, taking leave, etc. Reserved periods of a schedule can occur in regular and irregular cycles, such as on a daily basis or according to other cycles, as in weekly, monthly, every other day, etc., and with periods that are scheduled exceptions to a cycle.

Various scheduling systems have been developed in attempts to make task management more effective. Traditional time/project management systems are commonly utilized to simply fill spaces of available time in a schedule. Some previously-developed scheduling systems fill available spaces of time according to criteria commonly designated by a system user or administrator. The criteria are often external to a task itself, associating the thing to be performed in the task, such as a writing project, with some user-designated genre, such as genres like “school-related”, “work-related”, etc. created by the system user. These external criteria translate to scheduling rules giving a level of priority to tasks according to the categories defined by the system user. This type of scheduling system assigns a new task to an available time slot in a schedule according to a category associated with the task. Unfortunately, in these types of systems the scheduling of tasks is often only adjusted or readjusted based on external changes. The external changes are commonly implemented through human intervention, such as when new tasks are added or if a user changes current priorities which are implemented through a scheduling system being used.

Other types of previously-developed scheduling systems attempt to aggregate multiple factors regarding various external criteria which may be user-designated or otherwise provided. Although these multi-factor systems attempt to provide greater flexibility as to how or why tasks are prioritized in a schedule, these systems also generally rely on external intervention to implement adjustments to a previously determined task order or a priority being followed in the scheduling of tasks.

Several problems arise from these previously-developed methodologies: the user may be required to manually calculate how to best use their time, which is a time consuming and error prone process. In this type of circumstance, a user may be called upon to continuously readjust their schedule due to new tasks being added to a schedule. Other changes to a user schedule are often associated with the increasing level of multitasking in a work force including the user of the scheduling system. As more tasks are added among the work force and/or the interactivity of the individual user increases, the complexity of scheduling for the user commonly becomes exponentially more difficult.

Project management systems are often utilized to help ensure that projects, including underlying tasks, stay on schedule. A project management system may be coupled with a scheduling system to schedule tasks associated with a planned project. These types of project management systems often operate on the assumption that assigned tasks are completed according to schedule. But often this is not the case. Instead, tasks which are assigned and scheduled through a project management coupled scheduling system may be completed early or late. In addition, these types of coupled scheduling systems often fail to address the growing criticality of a task being completed as its associated due date or due-to-be-completed time approaches.

The above-described weaknesses of previously-developed scheduling systems are especially deficient for meeting the scheduling needs of individuals with very busy schedules. They are also deficient at meeting the needs of organizations with rigorous or tight deadlines such as, for example, “just-in-time” manufacturers and certain types of delivery services. The deficiencies also limit the scheduling and planning parameters available to large organizations engaged in real-time resource management, such as those engaged in managing their enterprise utilizing comprehensive business intelligence systems.

Given the foregoing, what is needed are scheduling systems, methods and computer-readable mediums without the above-identified limitations of previously-developed scheduling systems.

### BRIEF SUMMARY OF THE INVENTION

This summary is provided to introduce a selection of concepts. These concepts are further described below in the Detailed Description. This summary is not intended to identify key features or essential features of the claimed subject matter. Also, this summary is not intended as an aid in determining the scope of the claimed subject matter.

The present invention meets the above-identified needs by providing systems, methods and computer readable mediums (CRMs) for performing dynamic priority scheduling (DPS) which may utilize various intrinsic criteria associated with items for a schedule, such as flexible event durations, remaining flextime periods and time periods associated with time windows as well as methodologies based on the intrinsic criteria, such as factor-based determinations based on the intrinsic criteria associated with items for a schedule. The DPS systems, methods and CRMs, according to the principles of the invention, efficiently provide for addressing various scheduling needs, such as those of individuals with very busy schedules as well as the scheduling needs of organizations with rigorous or tight deadlines, such as those engaged in managing their enterprise utilizing comprehensive business intelligence systems.

These and other objects are accomplished by systems, methods and CRMs directed to dynamic priority scheduling, in accordance with the principles of the invention.

According to a first principle of the invention, there is a system for performing dynamic priority scheduling. The system may comprise an interface configured to access a schedule comprising a plurality of events and flextime periods associated with the schedule. The plurality may comprise at least one flexible event and at least one fixed event. The flexible event may be associated with a flexible event object comprising a FlexibleDueTime and one or more of a FlexibleStartTime and a FlexibleEventDuration. The processor may be configured to generate a priority value associated with the flexible event based on a time, the FlexibleDueTime, and one or more of the FlexibleStartTime and the FlexibleEventDuration and may determine a priority assignment of the flexible event utilizing the generated priority value.

According to a second principle of the invention, there is a method for performing dynamic priority scheduling. The method comprises accessing a schedule comprising a plurality of events and flextime periods associated with the schedule. The plurality may comprise at least one flexible event and at least one fixed event. The flexible event may be associated with a flexible event object comprising a FlexibleDueTime and one or more of a FlexibleStartTime and a FlexibleEventDuration. The method may also comprise generating, utilizing a processor, a priority value associated with the flexible event based on a time, the FlexibleDueTime, and at least one of the FlexibleStartTime and the FlexibleEventDuration. The method may also comprise determining a priority assignment of the flexible event utilizing the generated priority value.

According to a third principle of the invention, there is a non-transitory computer readable medium (CRM) storing computer readable instructions that when executed by a computer system perform a method for performing dynamic priority scheduling. The method comprises accessing a schedule comprising a plurality of events and flextime periods associated with the schedule. The plurality may comprise at least one flexible event and at least one fixed event. The flexible event may be associated with a flexible event object comprising a FlexibleDueTime and one or more of a FlexibleStartTime and a FlexibleEventDuration. The method may also comprise generating, utilizing a processor, a priority value associated with the flexible event based on a time, the FlexibleDueTime, and at least one of the FlexibleStartTime and the FlexibleEventDuration. The method may also comprise determining a priority assignment of the flexible event utilizing the generated priority value.

The above summary is not intended to describe each embodiment or every implementation of the present invention. Further features, their nature and various advantages will be more apparent from the accompanying drawings and the following detailed description of the examples and embodiments.

### BRIEF DESCRIPTION OF THE DRAWINGS

The features and advantages of the present invention become more apparent from the detailed description set forth below when taken in conjunction with the drawings in which like reference numbers indicate identical or functionally similar elements. Additionally, the left-most digit of a reference number identifies the drawing in which the reference number first appears.

In addition, it should be understood that the drawings in the figures which highlight the aspects, methodology, functionality and advantages of the present invention, are presented for example purposes only. The present invention is sufficiently flexible, such that it may be implemented in ways other than shown in the accompanying figures.

FIG. 1 is a block diagram illustrating a system which may be used for performing dynamic priority scheduling, according to an example;

FIG. 2 is a graph illustrating an impact of a duration-availability factor which may be utilized in performing dynamic priority scheduling using the system in FIG. 1, according to an example;

FIG. 3 is a graph illustrating an impact of a window-added factor which may be utilized in performing dynamic priority scheduling using the system in FIG. 1, according to an example;

FIG. 4 is a flow diagram showing a priority assignment process for determining a priority assignment of a task using the system in FIG. 1, according to an example;

FIG. 5 is a flow diagram showing a schedule initialization process for initially populating a schedule using the system in FIG. 1, according to an example;

FIG. 6 is a flow diagram showing a schedule update process for updating a schedule using the system in FIG. 1, according to an example;

FIG. 7A is a graphical representation of a schedule with no assigned flextime periods prepared using the system in FIG. 1, according to an example;

FIG. 7B is a graphical representation of a schedule with flexible events assigned to flextime periods prepared at a first time using the system in FIG. 1, according to an example;

FIG. 7C is a graphical representation of a schedule with flexible events assigned to flextime periods prepared at a second time using the system in FIG. 1, according to an example; and

FIG. 8 is a block diagram illustrating a computer system which provides a platform for the system in FIG. 1, according to an example.

### DETAILED DESCRIPTION

The present invention is useful for time management and scheduling applications, and has been found to be particularly advantageous for highly productive individuals and organizations which operate within the context of accomplishing numerous tasks having associated deadlines. While the present invention is not necessarily limited to such applications, as illustrated through the examples below, various aspects of the invention may be appreciated through a discussion of the various examples using this context.

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from the examples described below. The embodiments on which these examples are based are representative only. The selection of those embodiments to illustrate the principles of the invention does not indicate that variables, functions, conditions, techniques, configurations and designs, etc. which are not described in the examples are not suitable for use, or that subject matter not described in the examples is excluded from the scope of the appended claims and their equivalents. The significance of the examples can be better understood by comparing the results obtained therefrom with potential results which can be obtained from tests or trials that may be or may have been designed to serve as controlled experiments and provide a basis for comparison.

As used herein, the terms “based on”, “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This is done merely for convenience and to give a general sense of the description. This description should be read to include one, or at least one, and the singular also includes the plural unless it is obvious that it is meant otherwise.

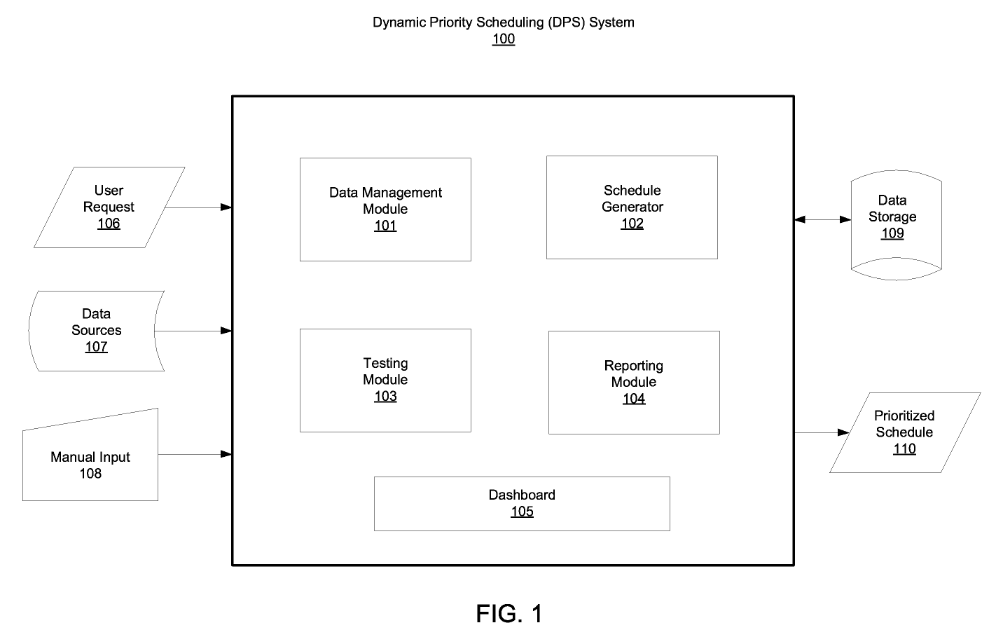

Referring to FIG. 1, depicted is a dynamic priority scheduling (DPS) system 100, according to an embodiment, for performing scheduling, such as dynamic priority scheduling. The DPS system 100 includes a data management module 101, a schedule generator 102, a testing module 103, a reporting module 104 and a dashboard 105. Modules, such as the modules 101, 103, 104 and the schedule generator 102, may include software, hardware, or a combination of both. The DPS system 100 receives data from a variety of sources, including user requests to access a schedule file, such as user request 106 and manual input 108. The manual input 108 may include user entered input data or request which may be received via the dashboard 105. The user may be connected to the DPS system 100 via a network or other forms of connection. The DPS system 100 may also receive input data from data sources, such as data sources 107.

Input data to the DPS system 100 may come from user request 106, data sources 107 and manual input 108. The input data may include information or updates regarding schedules, tasks and events associated with a user of the DPS system 100. Exemplary data from user request 106, data sources 107 and manual input 108 may include schedule files and objects regarding tasks and events such as fixed events associated with a set time period, such as a scheduled time for an educational class meeting. In addition exemplary data may include flexible events such as a task or a project to be completed at a set time (e.g., when it is due), but may be flexible as to an earlier completion before the set time.

A flexible event may be associated with a flexible event object that may include one or more of a FlexibleEventID, such as an alphanumeric identifier, a FlexibleStartTime, such as a discrete point in time or period of time in which the flexible event is known or stored, a FlexibleDueTime, such as a discrete point in time or period of time in which the flexible event is to be completed and a FlexibleEventDuration, such as an estimated length of time to complete a task or project. Similarly, a fixed event may be associated with a fixed event object that may include one or more of a FixedEventID, such as an alphanumeric identifier, a FixedStartTime, such as a discrete point in time or period of time in which the fixed event is known or stored, and a FixedStopTime such as a discrete point in time or period of time in which the fixed event ends or is otherwise completed.

The DPS system 100 stores data in data storage 109. The data storage 109 may include a data storage device which may store data organized in a manner which allows desired data, including information regarding users, user profiles, user schedules, schedule files, tasks, fixed events, flexible events, event objects and associated metadata. For example, the data storage 109 may include a relational database or an online analytical processing (OLAP) system for retrieving data. The information stored in the data storage 109 may be organized, for example, by category according to attributes, such as attributes associated with users, organizations, schedules, tasks, events, objects and links between attributes associated with one or more of these items. The data storage 109 may also store other data used by the DPS system 100.

The schedule generator 102 may communicate with the testing module 103, receiving feedback in the form of test results regarding provisional or proposed schedules for responding to user request 106. The schedule generator 102 may also communicate with the reporting module 104, which may provide, among other things, schedule updates to a user on schedule changes based on a change in priority due to such things as, for example, the passage of time, a response to a user request 106 or data from other data sources 107, such as an object associated with an event being changed such as if a meeting is changed, canceled or added, or if a duration associated with an event is modified.

A user request 106 may be utilized by the DPS system 100 and/or the schedule generator 102 in developing a schedule for utilization in various environments, such as a personal information management application, a personal computer program, a paper schedule, a project management program and a business intelligence network. A user may create an object for utilization as a schedule file. The object may include one or more fixed and/or flexible event(s) and optionally additional data types. The user may allow read/write access to changes to the object by additional users. The object can be defined as public (i.e., anyone can see and use without permission), private (i.e., invite/accept or request/accept before being associated with a specific user(s)) or hidden (i.e., where only the creator can see the object and invite other users to accept inclusion of the object). Fixed events and/or flexible events may be defined with one or more attributes such as a name or ID, a starting date or time, a stopping date or time, duration and, optionally, a description.

Users may be associated with object(s) which allow for a plurality of associated events to be aggregated into a user's calendar or schedule. Multiple users can be associated with one object, and with different access levels. Users may be associated with, for example, an object through an external source, such as a university supplying a list of courses a student is enrolled in and which professor is in charge of which course. This may be done by associating a course number with a unique object, thus automating and streamlining the initial enrollment by the student and professors. Users may also be associated, for example, by the request/invite and accept model for private/hidden objects.

By aggregating a user's associated objects, pluralities of events may be used to create a master list of events which can be included in a user's schedule and/or calendar. Error handling for overlapping fixed events may be included in which a user chooses which event to populate in the calendar. Changes by an object owner (date, duration, description change etc.) may be distributed throughout the schedules of associated users. Users may also have the option to exclude an object, include the entire object, all fixed events, all flexible events or specific events within the object to be aggregated in the user's event list. A user's schedule may include a note field to write notes for an event. A user may also be able to remove or modify an event or task in their schedule. A flexible event may have a duration associated with it, specified by the user or by another source. A user may modify an event or task duration to show partial completion of an event or to reflect an adjustment if an event requires more time.

Based on a user's scheduling time frame and the flextime periods in the time frame (i.e., free time available not occupied by fixed events or otherwise unavailable) a priority value may be dynamically assigned to flexible events associated with the user's schedule. The dynamic prioritization of flexible events in a user schedule may be accomplished by generating priority values for the flexible events in a user schedule. The priority values may be generated based on attributes associated with flexible events as well as flextime periods available based on such things as scheduled fixed events, blocked time periods and other attributes of a schedule. Based on the generated priority values, flexible tasks may be assigned priority assignments in the schedule. Higher priority values are generally associated with an assignment to earlier periods in the schedule, although other criteria may be applied such as lower priority assignments to earlier periods. In addition, various factors may also be utilized to more accurately or more precisely quantify the generated priority values for flexible events associated with a schedule.

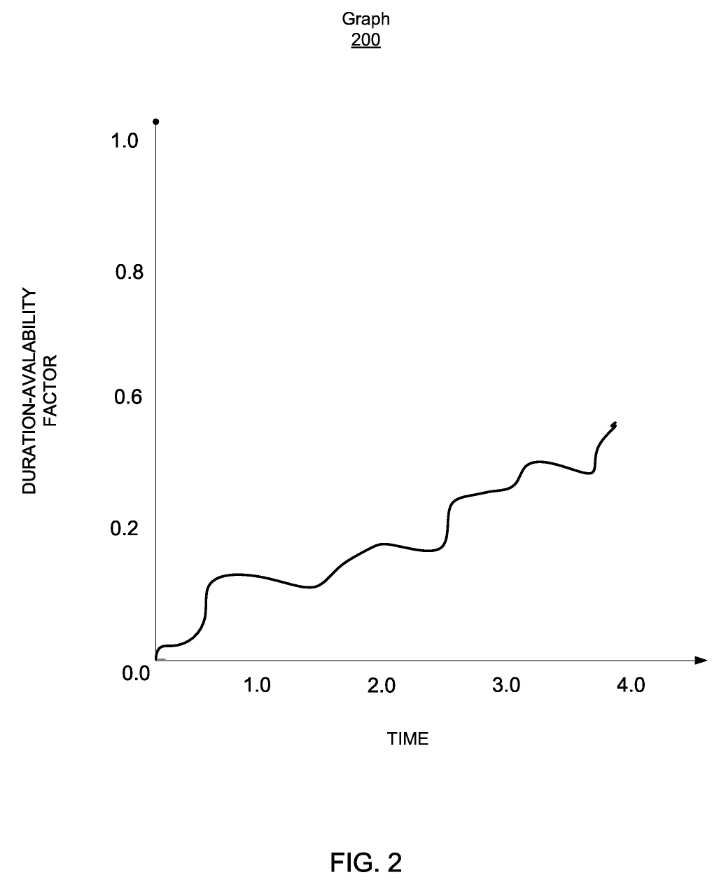

Referring to FIG. 2, depicted is a graph 200 illustrating the impact of a duration-availability factor on a flexible event priority assignment in a schedule. As demonstrated in graph 200, an impact of the duration-availability factor to the priority value associated with a flexible event may change as time progresses. Hence, the passing of time may itself affect the duration-availability factor. For example, as time passes and/or flextime periods become available in a window of time due to a schedule change, the duration-availability factor can also change. Also, free time may become available due to changes associated with events external to the DPS system 100, (e.g., a meeting is cancelled) or free time be taken up (e.g., a new meeting is scheduled) the duration-availability factor may then impact a determined priority value by increasing or decreasing it, accordingly. This may also occur if, for example, a flexible event's duration is changed.

The duration-availability factor can also be affected by an input or deletion of fixed event object associated with a schedule change, such as for example, a change to the FlexTimeRemaining. In addition, a modification to a flexible event under consideration, such as a change to the associated FlexibleEventDuration or FlexibleDueTime may also increase or decrease the impact of the duration-availability factor. A quantification of the duration-availability factor may be expressed mathematically by the equation:

$$duration \text{-} availability factor = \frac{FlexibleEventDuration}{FlexTimeRemaining} .$$

Note that the FlexibleEventDuration is a length of time associated with completing a task or other activity associated with the flexible event. The FlexTimeRemaining is a total time associated with a total of flextime periods in a time frame under consideration (i.e., a working window) with respect to the schedule involved.

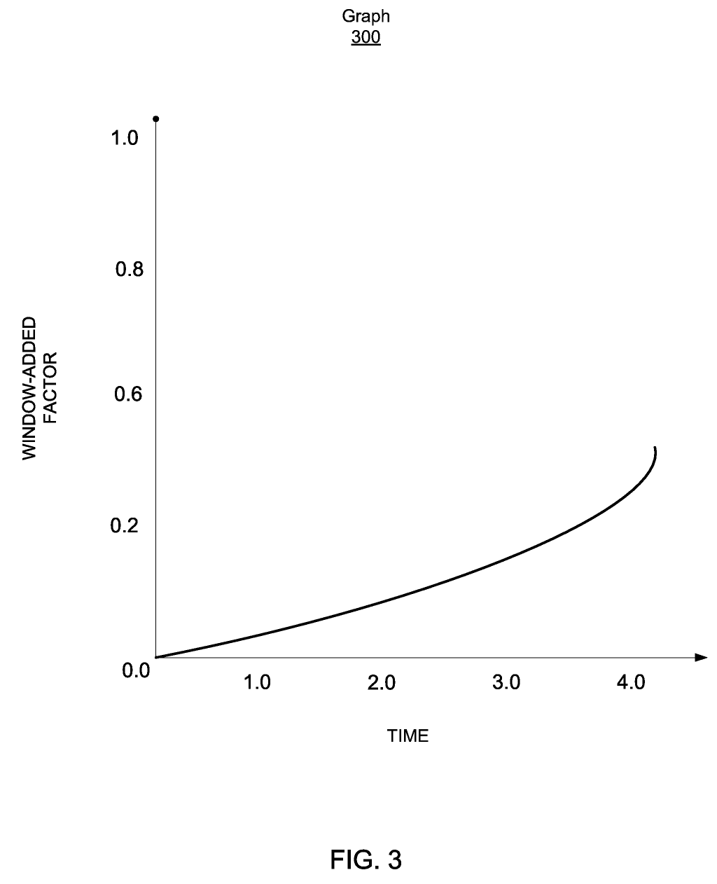

Referring to FIG. 3, depicted is a graph 300 illustrating the impact of a window-added factor on a flexible event priority assignment in a schedule. As demonstrated in graph 300, an impact of the window-added factor to the priority value associated with a flexible event may change as time progress. However, unlike the changing impact generally associated with the duration-availability factor, the impact of the window-added factor is generally a smooth curve.

Similar to the duration-availability factor, the window-added factor may be based on an AllTimeRemaining function (e.g., a working window of time associated with a schedule associated with a flexible event based on either the current time or another time such as the start time for the flexible event) and a TotalWindow associated with the FlexibleStartTime and the FlexibleDueTime. A quantification of the window-added factor may be expressed mathematically by the equation:

$$window \text{-} added factor = \frac{TotalWindow}{( TotalWindow + AllTime Remaining )} .$$

The DPS system 100 may utilize the duration-availability factor or the window-added factor, independently or together, in generating prioritization values for flexible events to determine their priority assignment in a schedule. For example, DPS system 100 may utilize them in combination to generate priority values. In this circumstance, a weighting may be used to modify the relative impacts of the two factors, relative to each other, and shift the impact associated with either of them. Any number of different variables may be utilized to establish the weighting including constant figures, such as 50% (i.e., applied equally) or a weighted variation such as a 20% window-added factor and an 80% duration-availability factor. When a weighting is used, the two factors may be utilized together to generate a priority value for a flexible event. This may be expressed mathematically by the equation:

$$priority value = ( \begin{matrix}weighting * ( window \text{-} added factor ) + \\ ( 1 - weighting ) * duration \text{-} availability factor )\end{matrix} ) .$$

In this equation, the window-added factor and the duration availability factor may be calculated by any of the variants described above. Another equation to express the priority value calculation mathematically is by the equation:

$$priority va l ue = ( \begin{matrix}weighting * ( \frac{TotalWindow}{( TotalWindow + AllTime Remaining )} ) + \\ ( 1 - weighting ) * ( \frac{FlexibleEventDuration}{FlexTimeRemaining} )\end{matrix} ) .$$

In this equation, the window-added factor and the duration availability factor may be calculated by any of the variants described above.

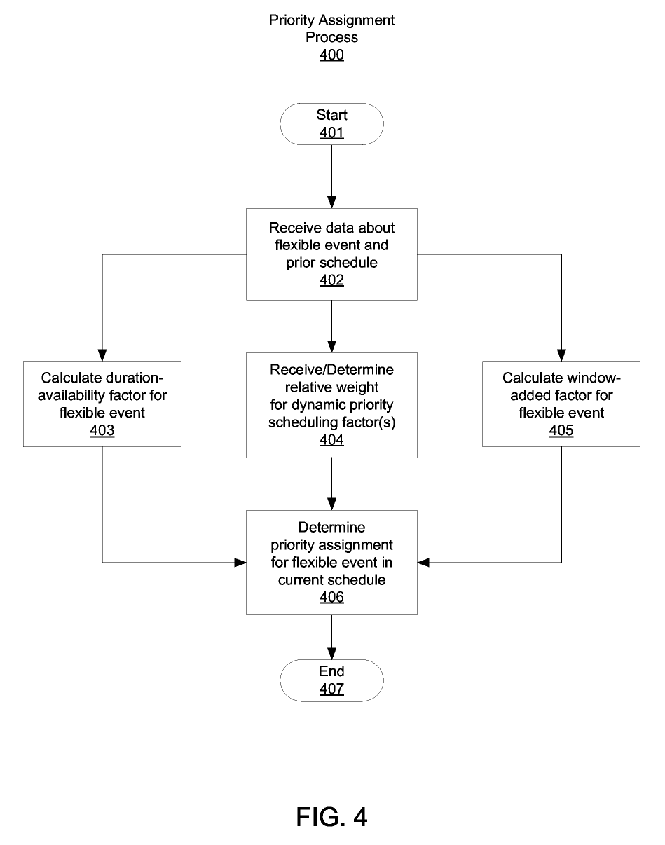

Referring to FIG. 4, depicted is a priority assignment process 400 for performing dynamic priority scheduling, according to an embodiment. The steps of method 400 and of other methods described herein are described by way of example with the DPS system 100. The methods may be performed with other systems as well.

After start 401, at step 402, the data management module 101 of the DPS system 100 shown in FIG. 1 receives data through an interface about a flexible event and prior schedule. The data may be input data such as manual input 108 and from external data sources 107. Alternatively, the data may be accessed from the data storage 109. The schedule may comprise a plurality of events (flexible and/or fixed) and flextime periods associated with the schedule. The plurality comprises at least one flexible event and at least one fixed event. The flexible event may be associated with a flexible event object including one or more of a FlexibleEventID, a FlexibleStartTime, a FlexibleDueTime a FlexibleEventDuration. The fixed event may be associated with a fixed event object including one or more of a FixedEventID, a FixedStartTime and a FixedStopTime.

Steps 403 and 405 may be performed in any order relative to each other and both relate to generating a priority value associated with the flexible event based on one or more of a duration-availability factor, a window-added factor and a weighting. In addition, step 404 is an optional step for incorporating a weighting to establish the relative impact of the factors developed in steps 403 and 405 when both of these are used together, according to an example.

At step 403, the schedule generator 102 calculates a duration-availability factor impact for the flexible event. The calculation may be based on one or more of the FlexibleEventDuration, the FlexibleDueTime, a time, and a FlexTimeRemaining associated with the time and the flexible event.

According to an example, the weighting may optionally be utilized at this point. At step 404, the schedule generator 102 may receive and/or determine a weighting and calculate a duration-availability factor impact for the flexible event. The calculation may be based on one or more of the FlexibleEventDuration, the FlexibleDueTime, a time, and a FlexTimeRemaining associated with the time and the flexible event. The time may be a current time or another time.

At step 405, the schedule generator 102 may calculate a window-added factor impact for the flexible event. The calculation may be based on one or more of a TotalWindow associated with the FlexibleStartTime and the FlexibleDueTime, and an AllTimeRemaining associated with the time and the FlexibleDueTime associated with the time and the flexible event. The TotalWindow may be a period of time occurring between the FlexibleStartTime and the FlexibleDueTime. The AllTimeRemaining may be a period of time occurring between the time and the FlexibleDueTime.

Prior to end 407, at step 406, the schedule generator 102 determines a priority assignment for the flexible event in the current schedule based on the values determined in steps 403-405 for the duration-availability factor, the window-added factor and the weighting.

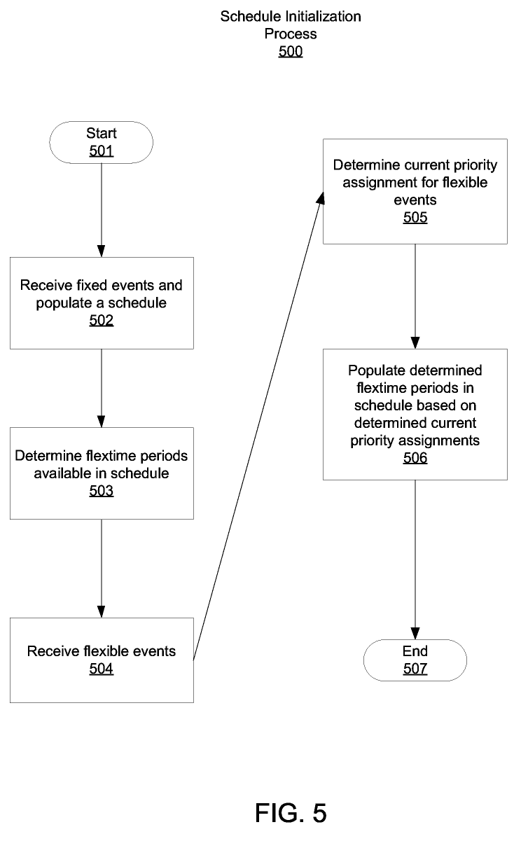

Referring to FIG. 5, depicted is a schedule initialization process 500 for initially populating a schedule.

After start 501, at step 502, the data management module 101 receives fixed events and populates a schedule with them.

At step 503, the schedule generator 102 determines the flextime periods available in the schedule populated in step 502.

At step 504, the data management module 101 receives flexible events to be associated with the schedule populated in step 502.

At step 505, the schedule generator 102 determines current priority assignments (e.g., as of the current time) for the flexible events in the schedule utilizing the steps described in priority assignment process 400.

Prior to end 507, at step 506, the schedule generator 102 populates the determined flextime periods from step 503 based on the determined current priority assignments of step 505.

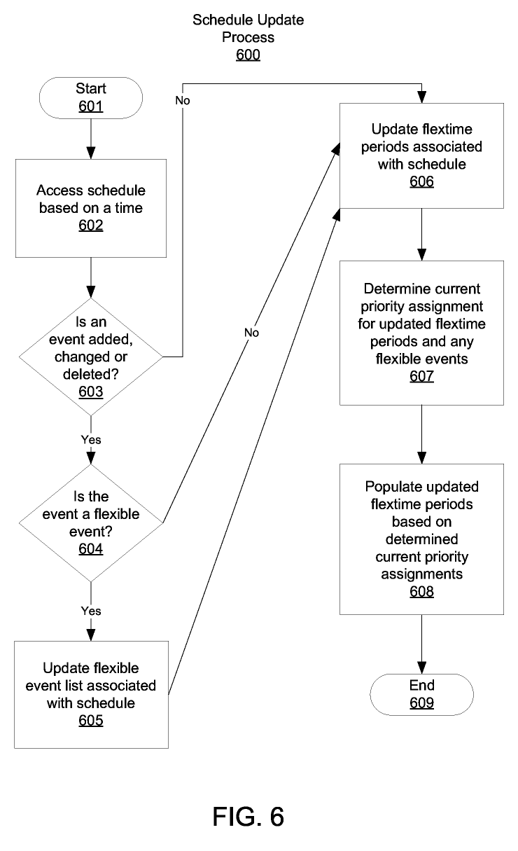

Referring to FIG. 6, depicted is a schedule update process 600 for updating a schedule based on an access of a stored schedule. A time of access may impact the calculation of a priority value for a flexible event in the schedule, as may other things such as data inputs 106, 107 and/or 108.

After start 601, at step 602, the data management module 101 accesses a schedule stored in data storage 109 based on a time associated with the access time. The accessed stored schedule may contain a plurality of fixed events and flexible events.

At step 603, the schedule generator 102 determines if any event is to be added, changed or deleted from the stored schedule. If any event (fixed or flexible) is to be added, changed or deleted, the schedule generator 102 determines an impact and determines a current priority of one or more flexible events already present in the accessed stored schedule. If an event (fixed or flexible) is to be added or deleted, at step 604, the schedule generator 102 determines if the event is a flexible event. If the event is a newly added flexible event, at step 605, the schedule generator 102 updates a flexible event list associated with the stored schedule. In the instance where an added new event is a flexible event, schedule generator 102 may also determine the current priority of the added new flexible event as well as the impact of adding the new added flexible event upon other flexible events in the accessed stored schedule.

At step 606, the schedule generator 102 updates the flextime periods associated with the stored schedule.

At step 607, the schedule generator 102 determines the current priority assignments for the updated flextime periods developed in step 606.

Prior to end 609, at step 608, the schedule generator 102 populates the updated flextime periods based on the determined current priority assignments.

### EXAMPLES

Exemplary schedules were prepared and tested according to the examples below. The schedules were used to demonstrate the generation of priority values for flexible events based on associated values developed for a duration-availability factor and/or a window-added factor associated with each flexible event at two different times. A priority assignment is demonstrated for the respective flexible events at each time based on the respective generated priority values.

### Example 1

Example 1 describes a preparation of a two-day schedule divided into quarter hour increments and populated with fixed events only. The two days covered by the schedule include a first day (i.e., “Today”) and a second day (i.e., “NextDay”). NextDay may immediately follow Today, or may be separated from Today by a number of days on an actual calendar. In addition, for purposes of examples 1-3 herein, a third day (i.e., “Yesterday”) relevant to the priority value determinations immediately precedes Today.

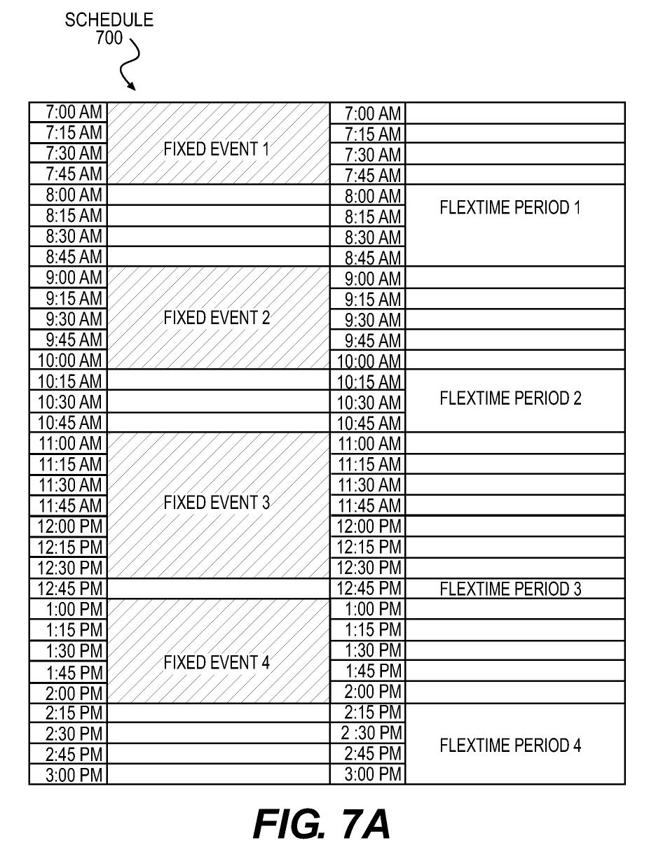

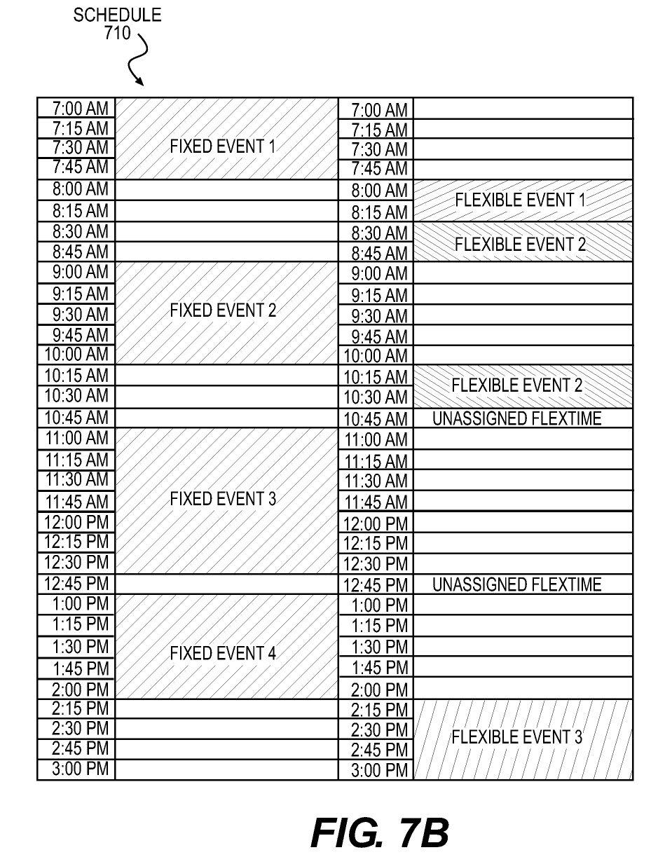

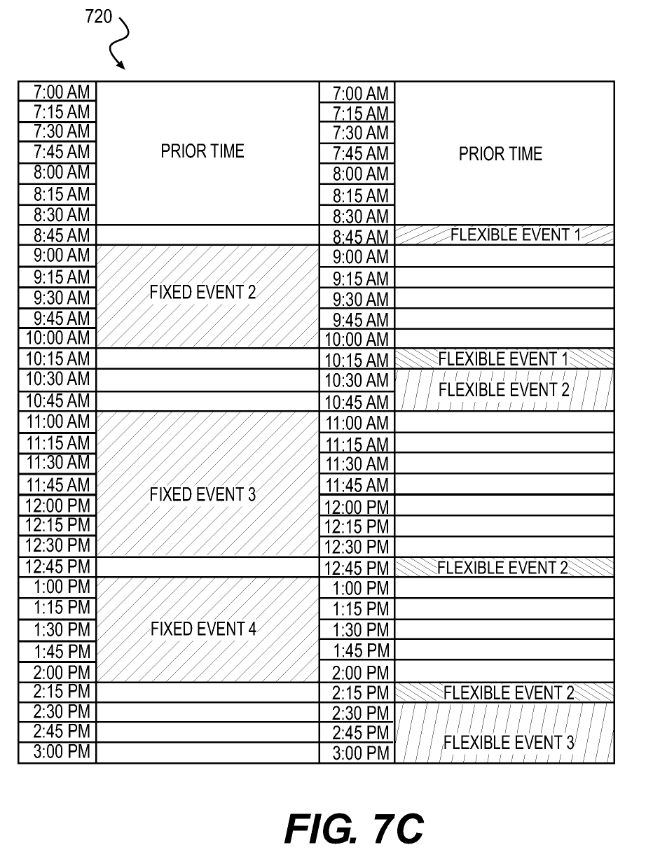

Referring to FIG. 7A, depicted is a schedule 700 showing a time frame within Today beginning at 7:00 AM and ending at 3:15 PM and divided into quarter hour increments. The schedule 700 includes four flextime periods used in priority assignments of flexible events in examples 2 and 3. Schedule 700 is populated with four fixed events: The first fixed event has a FixedEventID of “FIXED EVENT 1”, a FixedStartTime of 7:00 AM and a FixedStopTime of 8:00 AM. The second fixed event has a FixedEventID of “FIXED EVENT 2”, a FixedStartTime of 9:00 AM and a FixedStopTime of 10:15 AM. The third fixed event has a FixedEventID of “FIXED EVENT 3”, a FixedStartTime of 11:00 AM and a FixedStopTime of 12:45 PM. And the fourth fixed event has a FixedEventID of “FIXED EVENT 4”, a FixedStartTime of 1:00 PM and a FixedStopTime of 2:15 PM.

Also, as depicted in FIG. 7A, the placement of the fixed events in schedule 700 creates four flextime periods: FLEXTIME PERIOD 1 starts at 8:00 AM and ends at 9:00 AM; FLEXTIME PERIOD 2 starts at 10:15 AM and ends at 11:00 AM; FLEXTIME PERIOD 3 starts at 12:45 PM and ends at 1:00 PM; and FLEXTIME PERIOD 4 starts at 2:15 PM and ends at 3:00 PM. In addition, for purposes of calculating the priority values determined in examples 2 and 3 below, it is assumed that schedule 700 also includes 3 additional hours in one or more flextime period(s) starting after 3:15 PM on the same day (i.e., Today), and also 5 additional hours in one or more flextime period(s) on a following day (i.e., Tomorrow).

### Example 2

Example 2 describes a determination of priority values and priority assignments associated with three flexible events according to a schedule based on schedule 700 described above. The prepared schedule includes three flexible events associated with priority assignments into the flextime periods of schedule 700. The determinations are performed based on a time of Today, 8:00 AM.

Referring to FIG. 7B, depicted is a schedule 710 showing the priority assignment of three flexible events. The first flexible event has a FlexibleEventID of “FLEXIBLE EVENT 1”, a FlexibleStartTime of Yesterday, 8:00 AM (i.e., a day prior to Today, optionally immediately prior), a FlexibleDueTime of Today, 3:00 PM and a FlexibleEventDuration of 0.5 hours. The second flexible event has a FlexibleEventID of “FLEXIBLE EVENT 2”, a FlexibleStartTime of Yesterday, 8:00 AM, a FlexibleDueTime of Today, at midnight (i.e., 11:59.59 PM) and a FlexibleEventDuration of 1.0 hours. The third flexible event has a FlexibleEventID of “FLEXIBLE EVENT 3”, a FlexibleStartTime of Today, 2:15 PM, a FlexibleDueTime of Next Day, at midnight (i.e., 11:59.59 PM) and a FlexibleEventDuration of 1.0 hours.

Priority values were generated for all three flexible events based on a time of Today, 8:00 AM. In generating the priority value for the respective flexible events both a duration-availability factor and a window-added factor were utilized and the relative impact of each was determined using a weighting according to the equation:

$$priority value = ( \begin{matrix}weighting * ( \frac{TotalWindow}{( TotalWindow + AllTime Remaining )} ) + \\ ( 1 - weighting ) * ( \frac{FlexibleEventDuration}{FlexTimeRemaining} )\end{matrix} ) .$$

The weighting for the respective determined priority values was based on a sum of the required FlexibleEventDurations occurring before the earliest occurring FlexibleDueTime, which was Today at 3:00 PM for FLEXIBLE EVENT 1. Thus, for purposes of determining the weighting, the working window (i.e., the “X Window”) time period associated with the schedule in this example was the period occurring between Today, 8:00 AM and Today, 3:00 PM. The following equation was used to determine the weighting:

$$weighting = ( \frac{Sum ( Required FlexibleEventDurations in X Window )}{Sum ( flextime periods in X Window )} ) .$$

Referring to FIG. 7B, depicted is a schedule 710 showing the priority assignment of three flexible events. The first flexible event has a FlexibleEventID of “FLEXIBLE EVENT 1”, a FlexibleStartTime of Yesterday, 8:00 AM, a FlexibleDueTime of Today, 3:00 PM and a FlexibleEventDuration of 0.5 hours. The second flexible event has a FlexibleEventID of “FLEXIBLE EVENT 2”, a FlexibleStartTime of Yesterday, 8:00 AM, a FlexibleDueTime of Today, at midnight (i.e., 11:59.59 PM) and a FlexibleEventDuration of 1.0 hours. The third flexible event has a FlexibleEventID of “FLEXIBLE EVENT 3”, a FlexibleStartTime of Today, 2:15 PM, a FlexibleDueTime of Next Day, at midnight (i.e., 11:59.59 PM) and a FlexibleEventDuration of 1.0 hours.

All four flextime periods shown in FIG. 7A (i.e., “FLEXTIME PERIOD 1”, “FLEXTIME PERIOD 2”, “FLEXTIME PERIOD 3” and “FLEXTIME PERIOD 4”) fall within the designated working window occurring between Today, 8:00 AM and Today, 3:00 PM. The total time for the four flextime periods was 3.0 hours. However, the only required FlexibleEventDuration in the X Window was that associated with FLEXIBLE EVENT 1 lasting 0.5 hours. So the weighting in this example is 0.5 hours/3.0 hours, or 0.166666. This value for the weighting may change over time but is the same for priority value calculations for different flexible events.

According to this example, in calculating the duration-availability factor for FLEXIBLE EVENT 1 based on a time of Today, 8:00 AM, the FlexibleEvent Duration was 0.5 hours and the FlexTimeRemaining was 3.0 hours. In calculating the window-added factor for FLEXIBLE EVENT 1 based on a time of Today, 8:00 AM, the TotalWindow for each flexible event was the time period occurring between the corresponding FlexibleStartTime and the corresponding FlexibleDueTime for a respective flexible event. Thus, for example, the TotalWindow for FLEXIBLE EVENT 1 was the time period between Yesterday, 8:00 AM and Today, 3:00 PM equaling to 31 hours. The AllTimeRemaining was the time period occurring between the time, Today, 8:00 AM, and the FlexibleDueTime for the respective flexible event. Thus, for example, the AllTimeRemaining for FLEXIBLE EVENT 1 was the time period between Today, 8:00 AM and Today, 3:00 PM equaling to 7 hours. The window-added factor for FLEXIBLE EVENT 1 is based on a time of Today, 8:00 AM, is (31 hours/(7 hours+31 hours) or 0.81578.

In generating the priority value for FLEXIBLE EVENT 1, based on a time of Today, 8:00 AM, plugging into the first equation above shows the following:

$$priority value = ( \begin{matrix}0.16666 * ( \frac{31 hours}{( 31 hours + 7 hours )} ) + \\ ( 1 - 0.16666 ) * ( \frac{0.5 hours}{3.0 hours} )\end{matrix} )$$

The calculated priority value for FLEXIBLE EVENT 1 is about 0.27485. Similar calculations for FLEXIBLE EVENT 2 generated a priority value of about 0.25617 and for FLEXIBLE EVENT 3 generated a priority value of about 0.16886

Referring again to FIG. 7B, the flexible events are designated with priority assignments to the available flextime periods in schedule 710 based on the relative size of the generated priority value with flexible events having a higher generated priority value being assigned earlier flextime periods. Note that in this example, the FlexibleStartTime for FLEXIBLE EVENT 3 is Today, 2:15 PM as noted above.

### Example 3

Example 3 describes a determination of priority values and priority assignments associated with the three flexible events in example 2 based on schedule 700 depicted in FIG. 7A described above. However, the priority value determinations for the flexible events are performed based on a later time of Today, 8:45 AM. Although events occurring prior to Today, 8:45 AM may be maintained be a DPS system, they have been removed from the time frame shown in FIG. 7C as they no longer have an impact on a determination of a priority value.

Using the same equation utilized above in example 2, the calculated priority value based on a time of Today, 8:45 AM for FLEXIBLE EVENT 1 is about 0.35778. Similar calculations for FLEXIBLE EVENT 2 generated a priority value of about 0.30673 and for FLEXIBLE EVENT 3 generated a priority value of about 0.19702.

Referring to FIG. 7C, depicted is a schedule 720 showing the priority assignment of the three flexible events: FLEXIBLE EVENT 1, FLEXIBLE EVENT 2 and FLEXIBLE EVENT 3 based on a time of Today, 8:45 AM. The flexible events are designated with priority assignments to the available flextime periods in schedule 720 based on the relative size of the generated priority value with flexible events having a higher generated priority value being assigned earlier flextime periods.

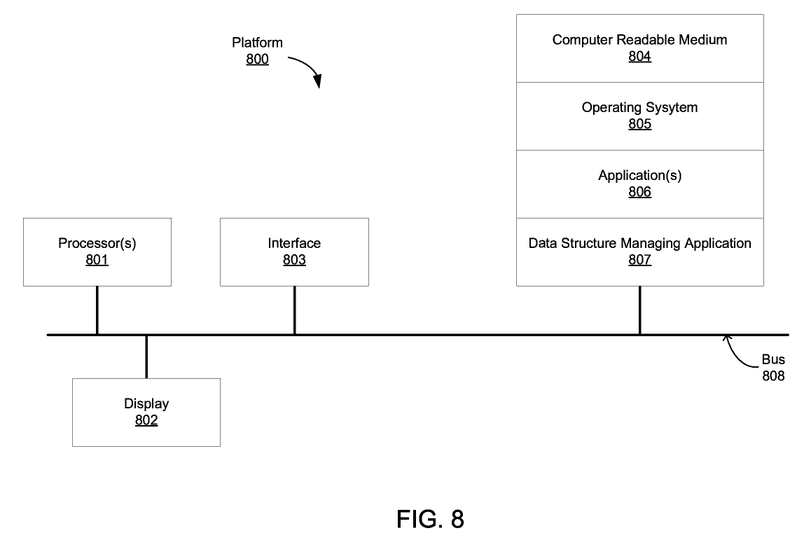

Referring to FIG. 8, there is shown a platform 800, which may be utilized as a computing device in a DPS system, such as DPS system 100. The platform 800 may also be used as a client device which may transmit requests and/or receive a schedule prepared by the DPS system 100. It is understood that the depiction of the platform 800 is a generalized illustration and that the platform 800 may include additional components and that some of the components described may be removed and/or modified without departing from a general scope of the platform 800.

The platform 800 includes processor(s) 801, such as a central processing unit; a display 802, such as a monitor; an interface 803, such as a simple input interface and/or a network interface to a Local Area Network (LAN), a wireless 802.11x LAN, a 3G or 4G mobile WAN or a WiMax WAN; and a computer-readable medium (CRM) 804. Each of these components may be operatively coupled to a bus 808. For example, the bus 808 may be an EISA, a PCI, a USB, a FireWire, a NuBus, or a PDS.

A CRM, such as CRM 804 may be any suitable medium which participates in providing instructions to the processor(s) 801 for execution. For example, the CRM 804 may be non-volatile media, such as an optical or a magnetic disk; volatile media, such as memory; and transmission media, such as coaxial cables, copper wire, and fiber optics. Transmission media can also take the form of acoustic, light, or radio frequency waves. The CRM 804 may also store other instructions or instruction sets, including word processors, browsers, email, instant messaging, media players, and telephony code.

The CRM 804 may also store an operating system 805, such as MAC OS, MS WINDOWS, UNIX, or LINUX; application(s) 806, such as network applications, word processors, spreadsheet applications, browsers, email, instant messaging, media players such as games or mobile applications (e.g., “apps”); and a data structure managing application 807. The operating system 805 may be multi-user, multiprocessing, multitasking, multithreading, real-time and the like. The operating system 805 may also perform basic tasks such as recognizing input from the interface 803, including from input devices, such as a keyboard or a keypad; sending output to the display 802 and keeping track of files and directories on the CRM 804; controlling peripheral devices, such as disk drives, printers, image capture devices; and for managing traffic on the bus 808. The application(s) 806 may include various components for establishing and maintaining network connections, such as code or instructions for implementing communication protocols including those such as TCP/IP, HTTP, Ethernet, USB, and FireWire.

A data structure managing application, such as data structure managing application 807 provides various code components for building/updating a computer-readable system architecture, such as for a non-volatile memory, as described above. In certain examples, some or all of the processes performed by the data structure managing application 807 may be integrated into the operating system 805. In certain examples, the processes may be at least partially implemented in digital electronic circuitry, in computer hardware, firmware, code, instruction sets, or any combination thereof.

Technical effects associated with systems and methods associated with a DPS system, such as DPS system 100, include the dashboard 105 through which the DPS system 100 provides information to a user. The DPS system 100 provides a technical tool for an efficient scheduling of tasks associated with a user. Furthermore, utilizing the data management module 101, the DPS system 100 may modify a processing load on a processor, such as processor(s) 801. In addition, the functions/steps of processing data using the DPS system 100 provides information to a user through the reporting module 104, the dashboard 105 in the form of a technical tool for an intellectual task the user has to master, and hence contributes to the technical solution of a technical problem of efficient scheduling. The reporting module 104, the schedule generator 102 and the dashboard 105 may be used together in managing data processed through the DPS system 100. This allows the user to grasp their scheduling priorities faster and more accurately, facilitating task prioritization, and thus resulting in an improved, continued man-machine interaction.

DPS systems, such as the DPS system 100, and related methods and CRMs, according to the principles of the invention, may utilize various intrinsic criteria, such as flexible event durations, remaining flextime periods and time periods associated with time windows as well as methodologies, such as factor-based determinations based on the intrinsic criteria. The DPS systems, methods and CRMs efficiently provide for addressing various scheduling needs, such as those of individuals with very busy schedules as well as the scheduling needs of organizations with rigorous or tight deadlines such as those engaged in managing their enterprise utilizing comprehensive business intelligence systems.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to the figures, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant art who are not familiar with patent or legal terms or phraseology, to determine quickly from a cursory inspection the nature and essence of this technical disclosure. The Abstract is not intended to be limiting as to the scope of the present invention in any way.

What is claimed is:

1. A system for performing dynamic priority scheduling, comprising:
an interface configured to
access a schedule comprising a plurality of events and flextime periods associated with the schedule, the plurality comprising at least one flexible event and at least one fixed event, wherein
the flexible event is associated with a flexible event object comprising a FlexibleDueTime and at least one of
a FlexibleStartTime, and
a FlexibleEventDuration; and
a processor configured to
generate a priority value associated with the flexible event based on
a time,
the FlexibleDueTime, and
at least one of
the FlexibleStartTime, and
the FlexibleEventDuration, and
determine a priority assignment of the flexible event utilizing the generated priority value.

2. The system of claim 1, wherein the processor is configured to generate the priority value based on at least one of
a duration-availability factor based at least on
the FlexibleEventDuration,
the FlexibleDueTime,
the time, and
a FlexTimeRemaining associated with the time and the flexible event, and
a window-added factor based at least on
a TotalWindow associated with the FlexibleStartTime and the FlexibleDueTime, and
an AllTimeRemaining associated with the time and the FlexibleDueTime.

3. The system of claim 1, wherein the interface is configured to receive input data comprising at least one of
an input fixed event object,
an input flexible event object, and
a modification to at least one of the flexible event and the fixed event, and
the processor is configured to
generate the priority value associated with the flexible event based on the input data and at least one of
the duration-availability factor and
the window-added factor, and
determine a priority assignment of the flexible event utilizing the generated priority value, and
the data management module is configured to
update the accessed schedule based on the determined priority assignment.

4. The system of claim 3, wherein the modification is one of
a deletion of the fixed event from the accessed schedule,
a deletion of the flexible event from the accessed schedule, and
a change in at least one of the FlexibleEventDuration and the FlexibleDueTime associated with the flexible event.

5. The system of claim 4, wherein the processor is configured to generate the priority value based on both the duration-availability factor and the window-added factor.

6. The system of claim 5, wherein the processor is configured to process the duration-availability factor according to the equation:
$$duration \text{-} availability factor = \frac{FlexibleEventDuration}{FlexTimeRemaining} .$$

7. The system of claim 5, wherein the processor is configured to process the window-added factor according to the equation:
$$window \text{-} added factor = \frac{TotalWindow}{( TotalWindow + AllTime Remaining )} .$$

8. The system of claim 5, wherein the processor is configured to generate the priority value using a weighting to modify the relative impact of the duration-availability factor and the window-added factor according to the equation:
$$priority value = ( \begin{matrix}weighting * ( window \text{-} added factor ) + \\ ( 1 - weighting ) * duration \text{-} availability factor )\end{matrix} ) .$$

9. The system of claim 8, wherein the weighting is based on a sum of a number of flexible events associated with the schedule within a time period associated with the schedule.

10. The system of claim 8, wherein the weighting is based on a sum of time periods associated, respectively, with a number of flexible events associated with the schedule within a time period associated with the schedule.

11. The system of claim 8, wherein the processor is configured to generate the priority value according to the equation:
$$priority value = ( \begin{matrix}weighting * ( \frac{TotalWindow}{( TotalWindow + AllTime Remaining )} ) + \\ ( 1 - weighting ) * ( \frac{FlexibleEventDuration}{FlexTimeRemaining} )\end{matrix} ) .$$

12. A method for performing dynamic priority scheduling, comprising:
accessing a schedule comprising a plurality of events and flextime periods associated with the schedule, the plurality comprising at least one flexible event and at least one fixed event, wherein
the flexible event is associated with a flexible event object comprising a FlexibleDueTime and at least one of
a FlexibleStartTime, and
a FlexibleEventDuration;
generating, utilizing a processor, a priority value associated with the flexible event based on
a time,
the FlexibleDueTime, and
at least one of
the FlexibleStartTime, and
the FlexibleEventDuration; and
determining a priority assignment of the flexible event utilizing the generated priority value.

13. The method of claim 12, wherein generating the priority value is based on at least one of
a duration-availability factor based at least on
the FlexibleEventDuration,
the FlexibleDueTime,
the time, and
a FlexTimeRemaining associated with the time and the flexible event, and
a window-added factor based at least on
a TotalWindow associated with the FlexibleStartTime and the FlexibleDueTime, and
an AllTimeRemaining associated with the time and the FlexibleDueTime.

14. The method of claim 12, further comprising
updating the accessed schedule based on the determined priority assignment.

15. The method of claim 12, wherein the time coincides with accessing the schedule.

16. The method of claim 12, wherein the FlexTimeRemaining is a sum of flextime periods associated with the schedule and occurring between the time and the FlexibleDueTime

17. The method of claim 12, wherein the TotalWindow is a period of time occurring between the FlexibleStartTime and the FlexibleDueTime.

18. The method of claim 12, wherein AllTimeRemaining is a period of time occurring between the time and the FlexibleDueTime.

19. The method of claim 12, wherein the generated priority value is based on both the duration-availability factor and the window added factor.

20. The method of claim 18, wherein the generated priority value is based on a weighting to modify the relative impact of the duration-availability factor and the window-added factor.

21. The method of claim 12, further comprising
receiving input data comprising at least one of
an input fixed event object,
an input flexible event object, and
a modification to at least one event in the plurality of events,
generating the priority value associated with the flexible event based on the input data and at least one of
the duration-availability factor and
the window-added factor, and
determining a priority assignment of the flexible event utilizing the generated priority value, and
updating the accessed schedule based on the input data and the determined priority assignment.

22. The method of claim 21, wherein the modification is one of
a fixed event change of the fixed event in the accessed schedule, wherein the fixed event change is one of an addition or deletion of the fixed event, a change in a scheduled time for the fixed event, and a change in at least one of a length of time, a duration, a start time and a due time associated with the fixed event,
a flexible event change of a second flexible event in the accessed schedule, wherein the flexible event change is one of an addition or deletion of the second flexible event and a change in at least one of a length of time, a duration, a start time and a due time associated with the second flexible event, and
a change in at least one of the FlexibleEventDuration and the FlexibleDueTime associated with the flexible event.

23. The method of claim 12, wherein generating the priority value is based on the duration-availability factor according to the equation:
$$duration \text{-} availability factor = \frac{FlexibleEventDuration}{FlexTimeRemaining} .$$

24. The method of claim 12, wherein generating the priority value is based on the window-added factor according to the equation:
$$window \text{-} added factor = \frac{TotalWindow}{( TotalWindow + AllTime Remaining )} .$$

25. The method of claim 12, wherein generating the priority value is based on a weighting to modify the relative impact of the duration-availability factor and the window-added factor according to the equation:
$$priority value = ( \begin{matrix}weighting * ( window \text{-} added factor ) + \\ ( 1 - weighting ) * duration \text{-} availability fac t or )\end{matrix} ) .$$

26. The method of claim 25, wherein the weighting is based on a sum of a number of flexible events associated with the schedule within a time period associated with the schedule.

27. The method of claim 25, wherein the weighting is based on a sum of time periods associated, respectively, with a number of flexible events associated with the schedule within a time period associated with the schedule.

28. The method of claim 25, wherein generating the priority value is done according to the equation:
$$priority value = ( \begin{matrix}weighting * ( \frac{TotalWindow}{( TotalWindow + AllTime Remaining )} ) + \\ ( 1 - weighting ) * ( \frac{FlexibleEventDuration}{FlexTimeRemaining} )\end{matrix} ) .$$

29. A non-transitory computer readable medium (CRM) storing computer readable instructions that when executed by a computer system perform a method for performing dynamic priority scheduling, the method comprising:
accessing a schedule comprising a plurality of events and flextime periods associated with the schedule, the plurality comprising at least one flexible event and at least one fixed event, wherein
the flexible event is associated with a flexible event object comprising a FlexibleDueTime and at least one of
a FlexibleStartTime, and
a FlexibleEventDuration;
generating, utilizing a processor, a priority value associated with the flexible event based on
a time,
the FlexibleDueTime, and
at least one of
the FlexibleStartTime, and
the FlexibleEventDuration; and
determining a priority assignment of the flexible event utilizing the generated priority value.

30. The CRM of claim 29, wherein generating the priority value is based on at least one of
a duration-availability factor based at least on
the FlexibleEventDuration,
the FlexibleDueTime,
the time, and
a FlexTimeRemaining associated with the time and the flexible event, and
a window-added factor based at least on
a TotalWindow associated with the FlexibleStartTime and the FlexibleDueTime, and
an AllTimeRemaining associated with the time and the FlexibleDueTime.

31. The CRM of claim 30, wherein generating the priority value is based on a weighting to modify the relative impact of the duration-availability factor and the window-added factor according to the equation:
$$priority value = ( \begin{matrix}weighting * ( window \text{-} added factor ) + \\ ( 1 - weighting ) * duration \text{-} availability fac t or )\end{matrix} ) .$$

32. The CRM of claim 31, wherein generating the priority value is done according to the equation:
$$priority value = ( \begin{matrix}weighting * ( \frac{TotalWindow}{( TotalWindow + AllTime Remaining )} ) + \\ ( 1 - weighting ) * ( \frac{FlexibleEventDuration}{FlexTimeRemaining} )\end{matrix} ) .$$
